(19) United States
(12) Patent Application Publication
(10) Pub. No.: US 2009/0123351 A1
(43) Pub. Date: May 14, 2009

(54) PROCESS FOR THE PREPARATION OF CALCIUM PHOSPHATE GRANULES OF THE HYDROXYAPATITE TYPE

(75) Inventors: Lorraine Leite, Paris (FR); Frederic Cobo, Perigny (FR)

Correspondence Address: MCCARTER & ENGLISH, LLP HARTFORD;CITYPLACE I, 185 ASYLUM STREET, HARTFORD, CT, 06103, US

(73) Assignee: INNOPHOS, INC., Cranbury, NJ (US)

(21) Appl. No.: 11/662,820

(22) PCT Filed: Jul. 7, 2005
(86) PCT No.: PCT/US2005/024067

§ 371 Date: Jan. 5, 2009

(30) Foreign Application Priority Data
Jul. 7, 2004 (FR) 04 07555

(51) Int. Cl. C01F 11/00; C01F 1/00

(52) U.S. Cl. 423/155; 423/305

(57) ABSTRACT

The objective of the present innovation is a new process for the preparation of calcium phosphate granules of the hydroxyapatite type. The preparation process of a business for the said granules based on the invention is a hydrolysis process of a brushite dicalcium phosphate, in a basic milieu which is characterised by the fact that an aqueous suspension of brushite dicalcium phosphate is treated with lime, in the presence of an effective quantity of a carboxylic acid.

The present application claims priority to French patent application no. 04 07555, filed Jul. 7, 2004, the entire contents of which are hereby incorporated by reference.

The objective of the present invention is a new process for the preparation of calcium phosphate granules of the hydroxyapatite type.

Calcium phosphates are used in the pharmaceutical industry as an excipient in the same manner as calcium carbonate. When the calcium content is high, they can also be calcium supplements, used in particular in the battle against osteoporosis in women. This is the case for hydroxyapatite, with the formula Ca₅(PO₄)₃(OH), which contains 39% calcium by weight.

The calcium phosphates also find use in numerous applications such as a reinforcing load, thermal insulation mass, polishing agent, support agent, construction material, or an additive for bucco-dental formulations, notably toothpastes or encapsulating agents. In the various end uses of calcium phosphate, a granular form is often required. In patent application FR n^{o} 03/08660, a new form of hydroxyapatite is described, specifically, in the form of granules resulting in a product with good flow and compressibility properties.

Hydroxyapatite is frequently referred to commercially by the term tricalcium phosphate. The ideal chemical formula for hydroxyapatite is Cas(PO₄)₃(OH). It is nevertheless well known in the literature that the crystal lattice which has this ideal formula is extremely receptive with respect to anion and cation substitutions in the lattice. The substitution of calcium cations by elements such as magnesium, strontium, barium, sodium, lead and a great number of other atoms is well known.

The substitution of anions in the lattice can take three different forms. Firstly, a part of the trivalent phosphate groups (PO₄³⁻) can be replaced by HPO₄²⁻ leading to a non-stoichiometric apatite. Secondly, the trivalent phosphate groups (PO₄³⁻) can be replaced by other complex anions such as the carbonates or vanadates. Thirdly, the hydroxyl group (OH⁻) can be partially or completely replaced by other anions such as fluoride or chloride.

A double substitution is also well known, in which an ion is replaced by another ion with a different charge, and the charge neutrality is maintained by substitutions elsewhere in the lattice by ions with different charges or by vacancies. In all of these substitutions, the factor that remains common and distinguishes the material as being a hydroxyapatite is its characteristic X-ray diffraction pattern.

Within the scope of the invention, the subject of the application FR n^{o} 03/08660, the term hydroxyapatite refers substantially to calcium phosphates which present the X-ray diffraction pattern of hydroxyapatite. The preparation process for hydroxyapatite in the granular form described in FR n^{o} 3/08660 is a hydrolysis process for brushite dicalcium phosphate in a basic milieu, preferably of sodium or potassium. This process offers a certain number of advantages: a simple, economical, concentrated process, and above all, this process offers the possibility of controlling the textural properties (granulometry, porosity) of the final hydroxyapatite by careful selection of the dicalcium phosphate which plays the role of raw material. Thus, it is possible to transform 200 micron granules of brushite dicalcium phosphate into 200 micron granules of calcium phosphate hydroxyapatite.

The invention makes reference to the following general equation for the alkaline hydrolysis of the brushite into hydroxyapatite:

5CaHPO₄2H₂O+4MOH+H₂O→Ca₅(PO₄)₃(OH)+2M₂HPO₄+14H₂O Equation [I]

in which M is the cation donated by the base, preferable an alkaline cation, for example, Na+, K+, NH₄+. The pH is maintained at a value of at least 7.0, preferably between 7 and 10 and more preferably between 8 and 8.5.

In accordance with the invention of FR n^{o} 3/08660, a hydroxyapatite is obtained in the form of granules which can be represented by the following formula:

Ca₅-χ(PO₄)₃-x(HPO₄)ₓ(OH)₁₋ₓ (I)

in the said formula, x varies between 0 and 1, preferably between 0.1 and 0.5. The invention includes the case where small quantities—for example, less than 5% by weight, preferably between 0.01 and 3% by weight—of calcium are substituted by another cation, in particular the basic cation (sodium, potassium). The invention also includes the case where small quantities of trivalent phosphate groups (PO₄³⁻) are substituted by complex anions (e.g., carbonate and vanadate) and hydroxyl ions replaced by another anion, for example, a halide, notably a chloride or fluoride.

As equation [I] shows, in addition to the hydroxyapatite are formed significant quantities of a hydrogenophosphate M₂HPO₄ which is difficult to recycle or increase in value. In addition, the hydrolysis of dicalcium phosphate using lime has already been described in two articles in the literature [J. Appl. Chem. Biotechnol. 1977, 27. 393-398 and Ceramics International, 29, 629-633 (2003)]. Nevertheless, the hydrolysis is carried out according to very restricted conditions, since it takes place under pressure in an autoclave, at an elevated temperature of 140° C. and with an excess of lime.

The Applicant found that it was possible to prepare the granules of calcium phosphate hydroxyapatite which present an X-ray diffraction pattern characteristic of the hydroxyapatite mineral, which functioned very well for use in particular as an excipient, and which enables the avoidance of the above-noted problem. What has now been found—and this is what constitutes the objective of the present invention—is a preparation process for calcium phosphate in a granular form displaying a hydroxyapatite X-ray diffraction pattern, by the hydrolysis of a brushite dicalcium phosphate, in a basic milieu characterised by the fact that an aqueous suspension of brushite dicalcium phosphate is treated with the aid of lime, in the presence of an effective quantity of a carboxylic acid.

The process of the invention offers numerous advantages. Thus, based on the process of the present invention, the secondary product which is co-produced is water. In addition, there are no metallic impurities introduced by the base, which enters the hydroxyapatite obtained.

The presence of the carboxylic acid, preferably acetic acid, has a doubly beneficial effect. It lowers the pH of the mixture which promotes the transformation of brushite dicalcium phosphate into calcium phosphate hydroxyapatite. In addition, it complexes the calcium, thereby making it more available for the reaction.

Other advantages will appear in the text concerning the process parameters.

In accordance with the improvement of the invention, the alkaline hydrolysis of brushite dicalcium phosphate into hydroxyapatite carried out with the help of lime can be represented by the following equation:

6CaHP0₄.2H₂O+4Ca(OH)₂+εRCOOH→Caio(P0₄)₆(OH)₂+18H₂O+εRCOOH Equation [III]

This novel calcium phosphate hydroxyapatite can be prepared by starting with a brashite calcium phosphate prepared by any known procedure which prepares brushite calcium phosphate as defined here. The granulometry of the said phosphate is chosen as a function of the application envisaged. Indeed, it has been found unexpectedly that the granulometry of starting didactic phosphate was conserved in the final hydroxyapatite.

For example, in the food field, it is in the fine powder form with an average d₅₀ particle diameter in the order of 10 μm.

For an application as an excipient, a calcium phosphate with good compressibility and flow characteristics is sought for direct compression applications. To obtain a calcium phosphate hydroxyapatite which has good flow characteristics, based on the invention, this material must have a granulometric distribution such that 90% of the particles by weight are less than about 300 microns and that at least 90% of the particles by weight are above about 10 microns. In order to achieve this, the brushite calcium phosphate starting material has a granulometric distribution such that 90% of the particles by weight are less than about 260 microns, and at least 90% of the particles by weight are above about 10 microns. This granulometric distribution can be obtained by elimination of the particles outside this range. The operation of granulometric selection is effected by screening. In a preferred method of production, the particle size expressed by the median diameter (d₅₀) is between 100 μm and 250 μm, preferably between 150 μm and 190 μm. The median diameter is defined as being that such that 50% by weight of the particles have a diameter greater than or less than the median diameter.

In addition, since the final hydroxyapatite product must comply with regulations governing the use of pharmaceutical constituents, the brushite calcium phosphate must also meet the purity requirements for pharmaceutical constituents, as they are detailed in the pharmacopoeia. Thus, the European pharmaceutical specifications for brushite calcium phosphate in the case of use in the pharmaceutical field are such that the CaHPO₄.2H₂O content is between 98.0 and 105.5%, and the chloride ion content is less than or equal to 330 ppm; the fluoride ion content is less than or equal to 100 ppm; the arsenic content is less than or equal to 10 ppm; the heavy metal and iron contents are less than or equal to 40 ppm and 400 ppm respectively.

The hydrolysis reaction can be carried out using any concentration of aqueous suspension of brushite. The brushite is kept in suspension during hydrolysis to ensure the obtaining of homogenous granules. The reactants are made to react preferably with a sufficient agitation in order to keep the brushite in aqueous suspension.

In practice, it is difficult to keep the brushite in suspension when the concentration exceeds about 50% by weight. It is preferably maintained between 20% and 40% by weight. Excessive agitation does not improve the speed of the reaction, and can lead to a breaking up of the particles with a corresponding loss in useful yield. In conformity with the process of the invention, a base is introduced, which is lime. Lime in the solid form is used, or in the fomm of an aqueous suspension (milk of lime) with a concentration between 5 and 20 g/l, preferably 10 g/l. The quantity of lime employed is close to the quantity which enables obtaining Ca/P molar equivalent of the hydroxyapatite. The Ca/P equivalent is best chosen between 1.5 and 1.7, preferably in the region of 1.6.

Based on the process of the invention, a carboxylic acid is employed. In an advantageous manner, a carboxylic acid is used which yields a calcium carboxylate which is soluble or partially soluble under reaction conditions. By “partially soluble”, is meant a solubility of the calcium carboxylate of preferably at least 10 g per litre of water measured at room temperature.

The carboxylic acids used preferentially are the aliphatic carboxylic acids having from 1 to 7 carbon atoms and preferably from 1 to 4 carbon atoms. As specific examples of carboxylic acids, methanoic acid, acetic acid, and propionic acid could be mentioned. Preferably, the carboxylic acid is acetic acid.

Carboxylic acid is used so as to lower the pH of the reaction milieu to between 6 and 10. The pH is preferably in the pH 7.0 range.

The process of the invention is preferably conducted at atmospheric pressure.

It is preferable to carry out the reaction at a temperature above room temperature (most frequently ranging between 15° C. and 25° C.), preferably above about 50° C. and even more preferably between 50° C. and 100° C. Most preferably, the temperature is between 90° C. and 95° C.

At temperatures below 50° C., it was determined that the reaction takes longer.

Based on the process of the invention, lime is introduced into the brushite dicalcium phosphate suspension, and the pH is adjusted to the above-noted range by the introduction of carboxylic acid.

From a practical viewpoint, the invention process can be implemented in a discontinuous or a continuous manner. Based on the first, discontinuous mode of implementation, the lime is added, in solid or milk of lime form to the aqueous suspension of brushite dicalcium phosphate. The addition is generally made at room temperature, that is, most often between 15° C. and 25° C.

Next, the carboxylic acid is added at room temperature in such a quantity as to obtain a pH between 6 and 10, preferably about 7. Once the pH has been established, the reaction mixture is brought to a temperature ranging between 54° C. and 100° C., preferably between 90° C. and 95° C.

The reaction milieu is continually agitated, and kept at the selected temperature for a period of time sufficient to obtain the transformation of the brushite calcium phosphate into calcium phosphate hydroxyapatite. The time required is generally between 1 hour and 24 hours, preferably between 6 hours and 8 hours.

On completion of the reaction, the mixture is allowed to cool to room temperature. The hydroxyapatite is obtained using the known techniques of solid/liquid separation, for example by filtration or centrifuging, preferably by filtration.

One or more washings can be carried out (for example, 2 or 3) with water in order to eliminate any traces of carboxylic acid. The quantity of water used is generally equivalent to one or two times the volume of the first filtrate.

The drying is generally carried out with air, preferably by heating of the calcium phosphate hydroxyapatite to a temperature between 80 and 120° C., preferably about 110° C., to eliminate the moisture absorbed by physical means.

The calcium phosphate hydroxyapatite which is prepared by means of the invention process displays an X-ray diffraction pattern equivalent to the X-ray diffraction of the hydroxyapatite. Also, the transformation of brushite calcium phosphate into calcium phosphate hydroxyapatite in which there is no transfer of anions or cations different from the composition of the hydroxyapatite.

Based on the continuous mode of applying the invention, the process begins with an aqueous suspension of brushite dicalcium phosphate. The suspension is raised to the reaction temperature ranging between 50° C. and 100° C., preferably between 90° C. and 95° C. The lime and the carboxylic acid are then introduced in parallel. The quantity of lime used is such that a Ca/P molar equivalence of between 1.5 and 1.7, preferably about 1.6, is obtained.

The quantity of carboxylic acid is adjusted so as to regulate the pH between 6, and 10, preferably in the range of 7. The rate of addition of the lime determines the quantity of carboxylic acid consumed. Thus, it is preferable to add the lime slowly, for example, over a period of time between 4 hours and 12 hours, preferably about 8 hours. The slower the addition of the lime, the smaller the amount of carboxylic acid used.

The reaction mixture is then maintained at a reaction temperature between 50° C. and 100° C., preferably between 90° C. and 95° C., for a period of time varying preferably between 12 and 20 hours. On completion of the reaction, (the material) is allowed to cool and the separation and drying operations are carried out as previously described.

The hydroxyapatite phosphate granules obtained by means of the present invention can be used in the pharmaceutical field.

The applications for the granules of the invention are the same as those of calcium phosphate and calcium carbonate.

In addition, they present the advantage of providing a calcium and phosphorus supplement in nutrition. The said elements play an important role in constitution and functioning of nerves, bones, muscles and teeth.

The granules from the invention notably offer the advantage of being directly useable in formulating active ingredients by direct compression. By “active ingredient” is meant any product intended to be administered orally which has a beneficial effect on, or effect desired by, the user. Thus, the active ingredient can be any product with pharmalogical properties, that is, having a preventive or curative action on a living organism.

Also included are products related to health and beauty such as, for example, vitamins or trace mineral element sources capable of being produced in the form of tablets.

As examples of active ingredients of the therapeutic type, the following non-limiting list of materials can be cited: the non-steroidal anti-rheumatics and anti-inflammatories (for example ketoprofen, ibuprofen, flurbiprofen, indomethacin, phenylbutazone, allopurinol, nabumetone), the opiate or non-opiate analgesics (for example paracetamol, phenacetine, aspirin), the antitussives (for example codein, codethyline, alimemazine), the psychotropics (for example trimipramine, amineptine, chlorpromazine and derivatives of the phenothiazines, diazepam, lorazepam, nitrazepam, meprobamate, zopiclone, and derivatives of the cyclopyrrolone family), the steroids (for example hydrocortisone, cortisone, progesterone, testosterone, prednisolone, triamcinolone, dexamethazone, betamethazone, paramethazone, fluocinolone, beclomethazone), the barbiturates (for example barbital, allobarbital, phenobarbital, pentobarbital, amobarbital), the anti-microbial agents (for example pefloxacine, sparfloxacine, and derivatives of the class of quinolones, tetracylines, synergistines, metronidazole), the medications intended for the treatment of allergies, notably the antiasthmatics, the antispasmodics and anti-blocking agents (for example omeprazole), the cerebral vasodilatators (for example quinacainol, oxprenolol, propranolol, nicergoline), the cerebral protectors, the hepatic protectors, the gastro-intestinal targeted therapeutic agents, the contraceptive agents, the oral vaccines, the antihypertensive agents and the cardiovascular or cardioprotective agents such as the beta blockers and the nitrate derivatives.

The quantity of active ingredient(s) in the prepared compounds based on the process of the present invention can vary within wide limits. It more specifically comprises between 0.001 and 95% by weight of the total composition, the remainder being ensured by the matrix.

In this way, the granules of calcium phosphate hydroxyapatite from the invention play the role of the principle constituent of the matrix. The calcium phosphate hydroxyapatite in general forms between 10% and 100% by weight of the matrix. It advantageously represents at least 80% and preferably at least 90% by weight of the matrix.

To the granules are added to advantage a lubricating agent such as magnesium stearate, in a quantity which is generally in the order of 0.5% by weight. To the granules can also be added a disintegrating agent to favour the subsequent disintegration of the tablets. This could be starch, notably corn starch or croscarmellose sodium, incorporated in a quantity which can vary between 5 and 10% by weight.

The matrix can also comprise one or more pharmaceutically acceptable excipients, more specifically diluting agents, binding agents, lubricating agents and colouring agents, and aromatic agents such as the saccharides, notably lactose and sucrose, fatty acids such as stearic acid for example; polyethylene glycol; other phosphates such as dicalcium phosphate, silica, the silicoaluminates, the cellulose derivatives, notably HMPC, Xanthane gum, gelatin, polyvinylpyrrolidone.

The invention granules can be mixed with the active ingredient or ingredients and possibly the other excipients of the composition, using any known solid/solid mixing method, and dry compressed by direct compression, that is without the use of water or an organic solvent such as ethanol.

The mixture obtained is subjected to a consecutive compression operation with a force that can range from 6 to 30 kN (measured at the level of the compression roller). This compression operation is preferably preceded by a pre-compression using a force which can range between 0.5 to 2.5 kN.

The granules obtained based on the invention are thus well adapted to the preparation of tablets.

So as to more fully illustrate the nature of the invention and the method of applying it, examples of the implementation of the invention are provided which are intended for illustrative purposes only and which are not limiting by nature.

These five examples illustrate various parameters, to with:
a concentration of brushite dicalcium phosphate suspensions between 12.5-400 g/1
an initial Ca/P molar correspondence varying between 1.5-1.67
different carboxylic acids: acetic (CT), propionic (C3)
different methods of application: discontinuous (examples 1 to 3) and semi-continuous (examples 4 and 5).

The invention makes reference to different attached figures.

FIG. 1 represents a photograph taken with a scanning electron microscope (SEM) which illustrates the morphology of the granules of calcium phosphate hydroxyapatite based on example 4 of the invention.

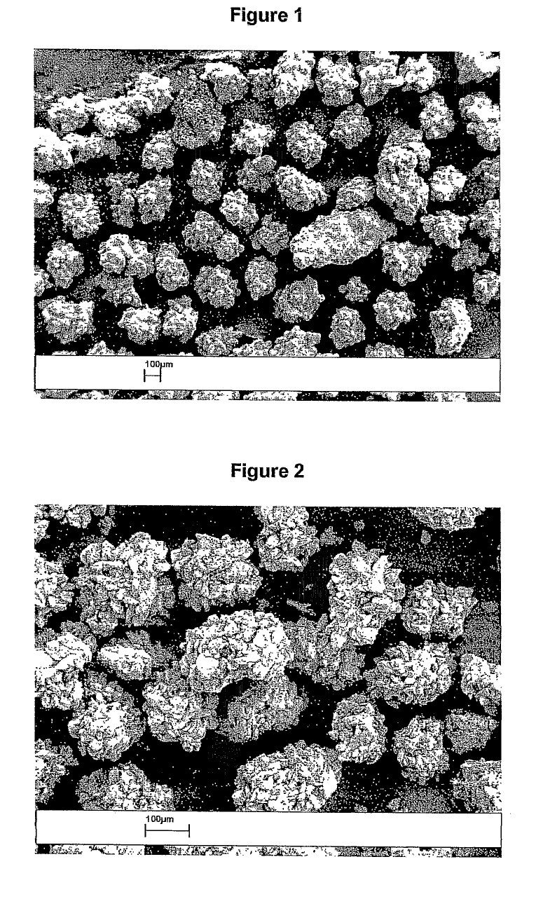

FIG. 2 represents a photograph taken with a scanning electron microscope (SEM) which illustrates the morphology of the granules of the initial brushite dicalcium phosphate.

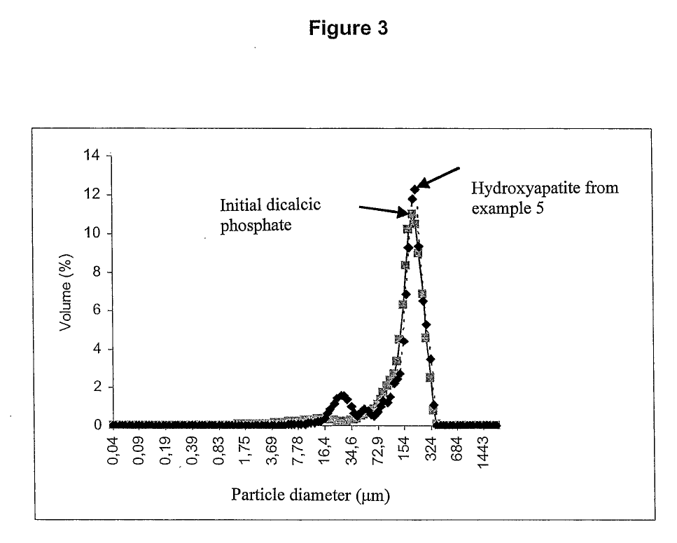

FIG. 3 represents a graph which corresponds to the cumulative curves for the determination of the median diameter (d₅₀) of example 5 compared to the initial brushite dicalcium phosphate.

### EXAMPLE 1

In a double jacket 2-litre reactor, at 25° C. with an agitation rate of 250 revolutions/minute (6 inclined blades), is mixed 10.324 g of dicalcium phosphate dihydrate: CaHPO₄.2H₂O, sold under the commercial name DiTAB by the Societe Rhodia, 2.964 g of calcium hydroxide [Ca(OH)₂] from PROLABO, RECTAPUR grade, and 800 g of deionised water.

The Ca/P ratio is 1.67.

The total volume of the suspension is 800 ml, and the DiTab concentration is 12.5 g/l.

Approximately 5 g of acetic acid [CH₃COOH] from PROLABO, 100% RECTAPUR grade, is introduced drop by drop to obtain a pH of 7.0.

The mixture is then heated to 95° C., with the temperature increase taking place over 30 minutes. After 24 hours at 95° C., the heating is discontinued and the mixture is allowed to cool to room temperature.

The product is then separated by filtration, washed with 3 times the volumes of water, and dried overnight in a drying oven at 100° C. This product displays an X-ray diffraction pattern typical of a hydroxyapatite.

### EXAMPLE 2

In a double jacket 2-litre reactor, at 25° C. with an agitation rate of 250 revolutions/minute (6 inclined blades), is mixed 10.324 g of dicalcium phosphate dihydrate: CaHPO₄.2H₂O, sold under the commercial name DiTAB by the Societe Rhodia, 2.964 g of calcium hydroxide from PROLABO, RECTAPUR grade, and 800 g of deionised water.

The Ca/P ratio is 1.67.

The total volume of the suspension is 800 ml, and the DiTab concentration is 12.5 g/i.

Approximately 6 g of propionic acid [CH₃CH₂COOH] from PROLABO, RECTAPUR grade, is introduced to obtain a pH of 7.0.

The mixture is then heated to 95° C., with the temperature increase taking place over 30 minutes. After 24 hours at 95° C., the heating is discontinued and the mixture is allowed to cool to room temperature. The product is then separated by filtration, washed with 3 times the volumes of water, and dried overnight in a drying oven at 100° C.

This product displays an X-ray diffraction pattern typical of a hydroxyapatite.

### EXAMPLE 3

In a double jacket 2-litre reactor, at 25° C. with an agitation rate of 250 revolutions/minute (6 inclined blades), is mixed 258.1 g of dicalcium phosphate dihydrate: CaHPO₄.2H₂O₅ sold under the commercial name DiTAB by the Societe Rhodia, 74.1 g of calcium hydroxide from PROLABO, RECTAPUR grade, and 400 g of deionised water.

The Ca/P ratio is 1.67.

The total volume of the suspension is 650 ml, and the DiTab concentration is 400 g/l.

Approximately 120 g of acetic acid from PROLABO, 100% RECTAPUR grade, is introduced to obtain a pH of 7.0.

The mixture is then heated to 95° C., with the temperature increase taking place over 30 minutes. After 24 hours at 95° C., the heating is discontinued and the mixture is allowed to cool to room temperature. The product is then separated by filtration, washed with 3 times the volumes of water, and dried overnight in a drying oven at 100° C.

This product displays an X-ray diffraction pattern typical of a hydroxyapatite.

### EXAMPLE 4

In a double jacket 2-litre reactor, at 25° C. with an agitation rate of 250 revolutions/minute (6 inclined blades), is mixed 233 g of dicalcium phosphate dihydrate: CaHPO₄.2H₂O, sold under the commercial name DiTAB by the Societe Rhodia, and 450 g of deionised water.

The Ca/P ratio is 1.67.

The total volume of the suspension is 540 ml.

The reactor is then heated to 95° C., with the temperature increase taking place over 30 minutes.

Over a period of 8 hours, using a peristaltic pump, a milk of lime consisting of a mixture of 67 g of calcium hydroxide from PROLABO, RECTAPUR grade, and of 200 g of water is introduced. This milk with a volume of 240 ml is kept under magnetic agitation.

The reactor pH is regulated with about 7 g of acetic acid from PROLABO, 100% RECTAPUR grade to maintain a pH less than 7.0. After addition of the milk of lime, the mixture is maintained at 95° C. for 16 hours, and the heating is discontinued and it is allowed to cool to room temperature.

The total volume of the suspension is 780 ml and the DiTab concentration is 300 g/l.

The product is then separated by filtration, washed with 3 times the volumes of water, and dried overnight in a drying oven at 100° C. This product displays an X-ray diffraction pattern typical of a hydroxyapatite.

The particle size expressed in terms of median diameter (d₅₀) determined by laser diffraction is 175 μm.

The observation by SEM as illustrated by FIG. 1 of 200 μm granules comprised of the agglomeration of acicular particles of 0.05×1 μm.

By way of comparison, FIG. 2 illustrates the SEM photo of the initial dicalic phosphate.

### EXAMPLE 5

In a double jacket 2-litre reactor, at 25° C. with an agitation rate of 250 revolutions/minute (6 inclined blades), is mixed 233 g of dicalcium phosphate dihydrate:

CaHPO₄.2H₂O, sold under the commercial name DiTAB by the Societe Rhodia, and 400 g of deionised water.

The Ca/P ratio is 1.60.

The total volume of the suspension is 490 ml.

The reactor is then heated to 95° C., with the temperature increase taking place over 30 minutes.

Over a period of 8 hours, using a peristaltic pump, a milk of lime consisting of a mixture of 60.16 g of calcium hydroxide from PROLABO, RECTAPUR grade, and 250 g of water is introduced. This milk with a volume of 290 ml is kept under magnetic agitation.

The reactor pH is regulated with about 4 g of acetic acid from PROLABO, 100% RECTAPUR grade to maintain a pH less than 7.0.

After addition of the milk, the mixture is maintained at 95° C. for 16 hours, and the heating is discontinued and it is allowed to cool to room temperature.

The total volume of the suspension is 780 ml and the DiTab concentration is 300 g/l.

The product is then separated by filtration, washed with 3 times the volumes of water, and dried overnight in a drying oven at 100° C.

This product displays an X-ray diffraction pattern typical of a hydroxyapatite

The particle size expressed in terms of median diameter (d₅₀) determined by laser diffraction is 195 μm.

As illustrated in FIG. 3, the initial dicalcium phosphate, and the final hydroxyapatite particle size distributions are identical.

1. A process for preparation of a calcium phosphate in the form of granules displaying an X-ray diffraction pattern of hydroxyapatite by hydrolysis of a brushite dicalcium phosphate, in a basic milieu wherein an aqueous suspension of brushite dicalcium phosphate is treated with lime in the presence of an effective quantity of a carboxylic acid.

2. Process according to claim 1 wherein the brushite calcium phosphate has a granulometric distribution such that 90% by weight of the particles are less than about 300 microns and that at least 90% by weight of the particles are larger than about 10 microns.

3. Process according to claim 2 wherein the size of the brushite dicalcium phosphate particles is such that the median diameter (d₅₀) is between 100 μm and 250 μm, preferably between 150 μm and 190 μm.

4. Process according to claim 1 wherein the aqueous suspension of brushite has a concentration between 20 and 40% by weight.

5. Process according to claim 1 wherein the lime is in solid form or in the form of milk of lime with a concentration between 5 and 20 g/l, preferably 10 g/l.

6. Process according to claim 1 wherein the quantity of lime used is such that the Ca/P ratio is between 1.5 and 1.7, preferably about 1.6.

7. Process according to claim 1 wherein carboxylic acid used is a carboxylic acid whose calcium salt is soluble or partially soluble under the reaction conditions.

8. Process according to claim 7 wherein the carboxylic acid is an aliphatic carboxylic acid with 1 to 7 carbon atoms and preferably 1 to 4 carbon atoms.

9. Process according to claim 8 wherein the carboxylic acid is methanoic acid, acetic acid, or propionic acid, preferably acetic acid.

10. Process according to claim 1 wherein the carboxylic acid is used in a manner to lower the pH of the reaction milieu to between 6 and 10, preferably about pH 7.0.

11. Process according to claim 1 wherein the reaction temperature is between 50° C. and 100° C., preferably between 90° C. and 95° C.

12. Process according to claim 1 wherein the reaction is carried out under atmospheric pressure.

13. Process according to claim 1 wherein lime is introduced into the suspension of brushite dicalcium phosphate and the pH is adjusted to the above mentioned range by the introduction of carboxylic acid.

14. Process according to claim 13 wherein the process is carried out in a discontinuous or continuous mode.

15. Process according to claim 1 wherein the milieu is maintained at a reaction temperature for a period of time sufficient to obtain the transformation of brushite dicalcium phosphate into calcium phosphate hydroxyapatite.

16. Process according to claim 1 wherein the calcium phosphate hydroxyapatite obtained is separated, preferably by filtration and that one or more water washings are carried out.

17. Process according to claim 1 wherein the calcium phosphate hydroxyapatite is dried at a temperature between 80 and 120° C., preferably in the region of 110° C.

18. Calcium phosphate in granular form displaying an X-ray diffraction pattern of hydroxyapatite obtained according to the process claim 1.

19. Phosphate according to claim 18 wherein it contains no anions or cations different from the composition of the hydroxyapatite.

20. Utilisation of calcium phosphate hydroxyapatite in the granular form obtained according to the process described in claim 1 as sources of phosphorus and calcium and/or as excipients in tablets.
